(19) United States
(12) Patent Application Publication
(10) Pub. No.: US 2026/0178473 A1
(43) Pub. Date: Jun. 25, 2026

(54) SIMULATED INTERACTIONS FOR PROCESS TESTING

(71) Applicant: Walmart Apollo, LLC, Bentonville, AR (US)

(72) Inventors: Aditya Venkat Kumarakrishnan, Forest Hills, NY (US); Dinesh Sardana, Wilton, CT (US)

(21) Appl. No.: 19/389,227

(22) Filed: Nov. 14, 2025

Related U.S. Application Data
(60) Provisional application No. 63/738,382, filed on Dec. 23, 2024.

(51) Int. Cl. G06F 11/3668

(52) U.S. Cl. CPC G06F 11/3692; G06F 11/3688

(57) ABSTRACT

Example implementations related to automated testing of processes are disclosed. In an example, historical interaction data is annotated to generate annotated interaction data. A synthetic user definition including one or more machine-interpretable instructions for tuning a language model is generated based on the annotated interaction data and a simulation request for implementing a test of at least one trained process is received. User interactions with the at least one trained process by a synthetic user are simulated based on the synthetic user definition. The simulated user interaction generates an interaction output. A determination is made whether at least one goal of the simulated user interaction was met and the interaction output is labeled based on the determination whether the at least one goal was met.

### CROSS REFERENCE TO RELATED APPLICATION

This application claims benefit to U.S. Provisional Patent Application No. 63/738,382, entitled “SIMULATED INTERACTIONS FOR PROCESS TESTING,” filed on Dec. 23, 2024, the disclosure of which is incorporated herein by reference in its entirety.

### TECHNICAL FIELD

This application relates generally to automated process testing, and more particularly, to automated testing of interaction processes.

### BACKGROUND

Some machine learning systems, such as artificial intelligence systems, large language models, and other trained models are used in user-facing roles. These systems may provide first-level user interactions. Current machine learning systems may generate unexpected or inappropriate responses when provided with certain inputs.

### BRIEF DESCRIPTION OF THE DRAWINGS

Various examples will be described below with reference to the following figures.

FIG. 1 depicts an example system for testing of trained processes using simulated users, in accordance with some embodiments.

FIG. 2 depicts an example system for generating annotated interaction data, in accordance with some embodiments.

FIG. 3 depicts an example method for testing of trained processes using simulated users, in accordance with some embodiments.

FIG. 4 depicts an example method for simulating a synthetic user, in accordance with some embodiments.

FIG. 5 depicts an example system with a machine-readable medium that includes instructions to perform process testing using a simulated users, in accordance with some embodiments.

FIG. 6 depicts an example system with a machine-readable medium that includes instructions to simulate a synthetic user, in accordance with some embodiments.

FIG. 7 depicts an example computer device that implements one or more of the disclosed processes, in accordance with some embodiments.

### DETAILED DESCRIPTION

Machine learning systems are increasingly being used for first-level user interactions, such as customer service interactions, technical troubleshooting, sales activities, etc. Deployment of machine learning models that behave in unpredictable or unexpected ways, such as providing inappropriate or unintended responses, can result in lower trust in both the models themselves and the entities deploying these models. However, current testing of complex systems, such as compound artificial intelligence (AI) systems, with robust end-user scenarios is challenging as users do not behave deterministically. For example, users may provide accidental or intentionally harmful inputs, may provide unexpected inputs, or otherwise may interact with deployed models in unanticipated ways that can create complications for current systems even when an input is expected and/or intended. Current deployment methodologies are unable to adequately test models across a range of potential user interactions, instead focusing on a set of known test cases that can miss or ignore other potential interactions that may result in erroneous or unintended outputs from the model.

The disclosed systems and methods enable automated testing of interaction systems that encompass wide ranges of user behaviors in order to capture and evaluate artificial intelligence system (e.g., model) performance for both expected and unexpected interactions. As discussed in greater detail below, in some embodiments, the simulation of user interactions by a synthetic user enables models or compound systems to be evaluated based on generated responses that mimic actual user interactions and that can adapt, during the interaction, to responses received from the process under test. The use of synthetic users for process testing provides an improvement over prior processes by allowing conversational testing of processes that extends beyond a set of known test cases or known inputs. The disclosed systems and methods provide both improvements to processing testing itself (e.g., by enabling a wider range of process testing that is flexible and adaptable to process outputs to test a wide range of scenarios) and to the training of automated compound systems, such as systems including trained machine learning models or large language models (LLMs) (e.g., by providing better feedback and evaluation of models that may be used to further adapt the models prior to and/or after deployment). These and other advantages will be apparent from the disclosure herein.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired or wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions is disclosed. The instructions, when executed, cause the processor to annotate historical data for at least one user to generate annotated interaction data, generate a synthetic user definition including one or more machine-interpretable instructions for tuning a language model based on the annotated interaction data, receive a simulation request for implementing a test of at least one trained process, simulate user interaction with the at least one trained process by a simulated user based on the synthetic user definition, and evaluate an interaction output to determine when the simulated user interaction achieved one or more goals. The simulated user interaction may generate the interaction output.

In various embodiments, a computer-implemented method is disclosed. The computer-implemented method includes steps of receiving a simulation request for implementing a test of at least one trained process, obtaining a synthetic user definition including one or more machine-interpretable instructions for tuning a language model based on annotated interaction data, generating a simulated user based on the synthetic user definition, simulating interactions between the simulated user and the at least one trained process, evaluating the interaction output to determine when the interactions achieved one or more predefined goals, and adjusting at least one parameter of the at least one trained process based on the evaluation of the interaction output. The simulated interactions generate the interaction output.

In various embodiments, a non-transitory computer-readable medium having instructions stored thereon is disclosed. The instructions, when executed by a processor, cause a device to perform operations including receiving a simulation request for implementing a test of at least one trained process, obtaining a synthetic user definition including one or more machine-interpretable instructions for tuning a language model based on annotated interaction data, generating a simulated user by applying the synthetic user definition to fine-tune a large language model, simulating interactions between the simulated user and the at least one trained process, wherein the interactions generate an interaction output, and evaluating the interaction output to determine when the interactions achieved one or more predefined goals.

Furthermore, in the following, various embodiments are described with respect to methods and systems for generating simulated users and using simulated users for testing and modification of trained processes or models. In various embodiments, historical data (e.g., anonymized historical data) representative of user interactions for one or more users is received. The historical data is annotated and one or more sets of annotated historical data (e.g., one or more sets of annotated historical interaction data) are utilized to generate a synthetic user definition. In some embodiments, the synthetic user definition includes one or more tags or identifiers indicative of one or more elements of the synthetic user (e.g., one or more simulated demographic elements, one or more simulated personality elements, one or more simulated memory elements, etc.). The synthetic user definitions may each be used to simulate a user having the traits (e.g., tags or identifiers) associated with the synthetic user definition. In some embodiments, a synthetic user may include a simulated user having one or more traits associated therewith.

In some embodiments, one or more trained compound AI systems (e.g., systems including trained machine learning and/or AI models and, optionally, additional elements) may be tested by initiating interactions between one or more simulated users and the one or more trained models. For example, in some embodiments, a synthetic user definition is provided to a compound simulation AI system that receives the synthetic user definition and simulates outputs of the synthetic user matching the elements of the synthetic user definition. The outputs of the compound simulation AI system are provided as inputs to the one or more trained compound AI systems, which in turn generate outputs based on the received inputs, which are provided back to the compound simulation AI system to generate further interactions (e.g., further inputs in response to the outputs of the one or more trained models and/or based on one or more synthetic user traits). In some embodiments, the simulated interaction includes one or more goals and the complete output of the interaction (e.g. a transcript of the interaction) is provided for scoring, review, and/or use in further adjustments of the one or more trained models.

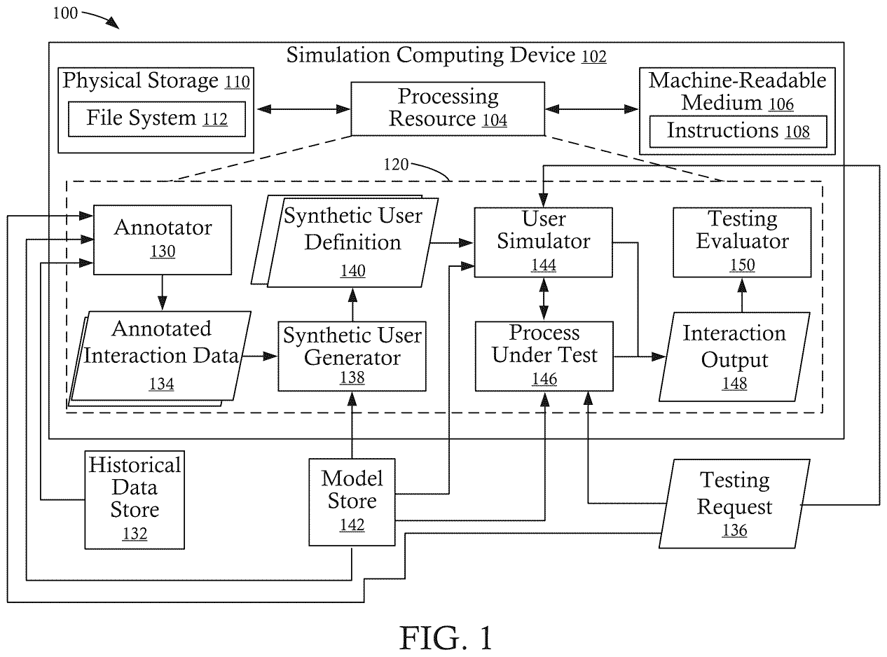

FIG. 1 depicts an example system 100 for testing of trained processes using simulated users, in accordance with some embodiments. The system 100 includes a simulation computing device 102 that provides for generation of synthetic user definitions and interactions between simulated users and one or more test processes. The simulation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The simulation computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on a machine-readable medium 106 to perform functions of the simulation computing device 102, such as receiving historical data, generating one or more synthetic user definitions, simulating interactions for the one or more synthetic users, executing one or more processes under test, analyzing interaction outputs, and/or revising/retraining one or mode processes based on the outcome of the simulated interaction(s). The instructions 108 may include instructions for implementing one or more models. In some embodiments, and as will be described further herein, the simulation computing device 102 may execute one or more models, processes, or algorithms, such as a machine learning model, deep learning model, statistical model, large language model, etc. (e.g., implemented as machine-readable instructions) to annotate data, generate synthetic user definitions, simulate a user, simulate interactions between a synthetic user and a test process, analyze interaction outputs, etc.

The simulation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the simulation computing device 102. In some implementations, physical storage 110 may be accessed as a block storage device.

In some cases, the simulation computing device 102 may also include a local file system 112 that may be implemented as a layer on top of the physical storage 110. For example, an operating system may be executing on the simulation computing device 102 (by virtue of the processing resource 104 executing certain instructions 108 related to the operating system) and the operating system may provide a file system 112 to store data on the physical storage 110.

In various embodiments, the simulation computing device 102 may be in communication with a web server, a cloud-based engine including one or more processing devices that may be provisioned for use, a database, a workstation, and/or any other suitable system or device. The simulation computing device 102 may similarly be in communication, either directly or indirectly, with one or more user computing devices operatively coupled over a network. The other computing systems may be similar to the simulation computing device 102, and may each include at least a processing resource and a machine-readable medium.

In some embodiments, the simulation computing device 102 includes an annotator 130 that receives historical data from a historical data store 132. The historical data may include, but is not limited to, historical user interaction data representative of user interactions (e.g., transcripts, network logs, order history, search history, etc.), transaction data (e.g., records of transactions or other exchanges of the user with one or more corresponding systems), user data (e.g., anonymized user-provided data such as user preferences, anonymized demographic information, etc.), system data (e.g., chat logs, emails, call transcripts), etc. The historical data, such as transcripts, may include historical interactions with automated systems (such as chatbots, LLMs, compound AI systems, etc.) and/or interactions with individuals (e.g., customer service agents). The historical user data may be anonymized prior to, simultaneous with, and/or after being received by the annotator 130.

The annotator 130 receives the historical data and outputs one or more sets of annotated interaction data 134. The annotated interaction data 134 may include historical data including one or more programmatically identified features and/or programmatically identified annotations. Features identified within the historical data may include, but are not limited to, one or more interaction elements such as tone, type, context, content, preferences, etc. In some embodiments, the annotated interaction data 134 may include labels related to one or more attributes such as trait labels, personality element labels, memory labels, and/or other labels identifying data as relating to and/or useful in determining one or more aspects of a simulated user.

In some embodiments, the annotator 130 receives one or more inputs indicating elements or features to be identified within the historical data. For example, an annotator 130 may receive a testing request 136 that includes a request for simulated users that have reported a delivery being stolen after delivery. The annotator 130 searches the available historical data to identify corresponding transcripts, e.g., transcripts in the historical data in which a user reported a delivery being stolen after delivery, and may apply one or more annotations based on the identified match of historical data, for example, applying an annotation indicating that an anonymized user was the victim of a “delivery theft.”

In some embodiments, the annotator 130 utilizes a vector embedding process to identify relevant historical data based on one or more features. For example, the annotator 130 may identify transcripts or other historical data having semantically similar elements to “delivery” and “theft” in order to identify historical interactions related to delivery thefts. The annotator 130 may utilize strict semantic matching, similar semantic matching, and/or other forms of semantic matching. The annotator 130 may, additionally or alternatively, utilize forms of feature matching other than vector embedding matching, such as dictionary matching, tag matching, etc. Although embodiments are discussed herein with respect to vector embedding processes, it will be appreciated that any suitable classification process can be used to identify data based on one or more features.

In some embodiments, the annotated interaction data 134 is provided to the synthetic user generator 138, which extracts and/or summarizes elements within annotated interaction data 134 to generate one or more synthetic user definitions 140. For example, in some embodiments, the synthetic user generator 138 synthesizes one or more interaction elements to generate one or more synthetic user attributes representative of an attribute or descriptor of a simulated personality, such as, for example, “forceful,” “passive,” “jovial,” “aggregable,” etc. As another example, in some embodiments, the synthetic user generator 138 extracts one or more interaction elements indicating synthetic user attributes, such as “tech-challenged,” “detail-oriented,” etc. The generated synthetic user definitions 140 (and/or the attributes thereof) may include any suitable format, such as, for example, a list of tags or indications associated with synthetic user behaviors, outputs, goals, etc. The attributes of each synthetic user definition 140 may be provided in any suitable format, such as a set of values, an ordered list, a string, a range, etc. Each synthetic user definition 140 may be provided in any suitable data format (i.e., machine interpretable instructions), such as, for example, a JSON. Although certain embodiments are discussed herein, it will be appreciated that the synthetic user generator 138 may generate any suitable attributes, attribute values, and/or synthetic user definitions 140. In some embodiments, the synthetic user definition 140 is in the form of and/or includes one or more elements defining a persona of the simulated user that may be used to tune or adjust a compound AI system and/or components thereof.

In some embodiments, the synthetic user generator 138 is a compound AI system including a fine-tuned LLM, referred to herein as a synthetic user generation system. Components of the synthetic user generation system (or data necessary to implement one or more components of the synthetic user generation system) may be obtained from any suitable data store, such as a compound system store 142. The synthetic user generation system receives one or more sets of annotated interaction data 134 and generates a synthetic user definition 140 corresponding to the one or more sets of annotated interaction data 134. The synthetic user generation system identifies aspects of a synthetic user definition 140 and assigns corresponding attribute tags, identifiers, or other attribute elements based on the identified aspects. In some embodiments, the synthetic user generation system receives one or more prompts defining attributes, tags, elements, personality types, personas, and/or other aspects of a synthetic user for identification or classification.

The synthetic user generator 138 may generate a synthetic user definition 140 for one or more sets of annotated interaction data 134 and/or may aggregate multiple sets of annotated interaction data 134 to generate a synthetic user definition. When generating a synthetic user definition from an individual set of annotated interaction data 134, the synthetic user generator 138 may utilize additional anonymized information and/or synthetic information, such as anonymized and/or synthetic user information, anonymized and/or synthetic search information, anonymized and/or synthetic order history, etc., to generate an attribute-rich synthetic user definition 140.

In some embodiments, the synthetic user generator 138 generates synthetic seeding data for a synthetic user definition 140. Synthetic seeding data may include, but is not limited to, synthetic memories, demographic attributes, order history, etc. The synthetic seeding data may be used to tune or adjust a compound AI system used to simulate users and/or user interactions. It will be understood that although anonymized user data may be used as an initial basis for one or more aspects of a synthetic user definition 140, each generated synthetic user is a synthetic creation and is not representative of any specific user and/or users found in the historical data.

A user simulator 144 may receive a testing request 136, e.g., the same testing request 136 received by annotator 130 to generate corresponding annotated interaction data 134 and/or a separate testing request 136, for initiating a test of one or more processes. In response to receiving the testing request 136, the user simulator 144 utilizes one or more synthetic user definitions 140 to simulate interactions between one or more synthetic users and trained process, referred to herein as a process under test 146. The user simulator 144 utilizes the attributes of the corresponding synthetic user definition 140 to simulate interactions, e.g., natural language inputs, prompt selections, responses, etc., with the process under test 146. In some embodiments, the synthetic user definitions 140 may be selected based on traits, features, goals, and/or any other suitable elements of the synthetic user definition 140. Although embodiments are discussed including receipt of a testing request 136 by the user simulator 144 after generation of one or more synthetic user definitions 140, it will be appreciated that generation of synthetic user definitions 140 according to specific annotation criteria, as discussed above, may be implemented in response to receiving a testing request 136.

During testing, the user simulator 144 simulates one or more users that interact with the process under test 146 by providing interactions (e.g., initial inputs, responses, selections, or other interactions) required or requested by the process under test 146. The process under test 146 may include any suitable trained process and/or sub-process, such as a trained model incorporated into a compound AI system, a standalone model, an algorithmic process, and/or any other suitable trained process. The interactions are generated in view of, i.e., from the perspective of, the simulated user. For example, a simulated user may have one or more personas or attributes indicating that the simulated user is “technically naive,” e.g., indicating the simulated user is not familiar or comfortable with technical concepts. When generating interactions, the user simulator 144 may mimic the technical discomfort by providing responses that ignore, misinterpret, or otherwise incorrectly respond to technical prompts, misuse or misstate technical terms or elements, or otherwise demonstrate the technical challenges faced by the simulated user. As another example, a simulated user may have a persona or attribute indicating that the user is “forceful,” and will mimic this attribute of the synthetic user definition 140 by providing emphatic or strong responses for the process under test 146. Although specific embodiments are discussed herein, it will be appreciated that simulated users may have a wide range of personality personas or attributes corresponding to the wide range of personalities or interactions that may be experienced by a process deployed for interaction with general users.

In some embodiments, a testing request 136 includes one or more goals or reasons for the simulated user in interacting with the process under test 146. The user simulator 144 utilizes the identified goals or reasons to generate inputs to the process under test 146 directed to achieving the identified goals or reasons. For example, a simulated user may have a target goal commensurate with the scope of the process under test 146, such as interacting with a chatbot to obtain hours for a physical location associated with the chatbot, a replacement of previously purchased item, services provided by the process under test or affiliated services, etc. As another example, a simulated user may have a non-target, or secondary, goal outside the scope of the process under test 146, such as engaging in off-topic conversations, attempting to avoid interactions with automated agents, etc. The simulated user may include multiple goals, such as a single target goal and one or more secondary goals. Although specific embodiments are discussed herein, it will be appreciated that the user simulator 144 may apply any suitable goals for a simulated user based on the synthetic user definition 140 and/or aspects of the simulation request for the process under test 146.

The user(s) simulated by the user simulator 144 may be selected based on one or more parameters of a testing request 136. For example, a testing request 136 may specify one or more required traits for each user that interacts with the process under test 146 during the simulated interaction. As another example, the testing request 136 may specify one or more memories for a simulated user. Memories include simulated or synthetic prior interactions or occurrences that are used to inform the output of a simulated user. Examples of memories may include, but are not limited to, one or more interaction periods indicating a last interaction with a system, retailer, etc., one or more specific prior experiences (e.g., prior positive interactions with process under test 146, prior negative interactions), one or more vague memories (e.g., simulation of vague third-hand knowledge of system), and/or any other suitable memory elements.

In some embodiments, the user simulator 144 implements a synthetic cognitive architecture that attempts to simulate essential representations and mechanisms that underlie cognition. The cognitive architecture may simulate (or mimic) aspects of cognition such as the crafting actions to achieve goals based on existing memories and/or attributes. In some embodiments, a synthetic cognitive architecture includes attributes (e.g., one or more attributes of a simulated personality), goals (e.g., one or more tasks or desired outputs for the simulated personality), initial memories (e.g., actions that preceded the currently simulated interaction), action plans (e.g., planned steps for achieving goals), and/or other elements. Synthetic cognitive architectures may iteratively initiate one or more actions, update one or more memories in response to the action, and formulate an action plan for a future action. In some embodiments, a synthetic cognitive architecture includes a reflection step to modify one or more goals that may be implemented at a predetermined number of iterations (e.g., each K iterations, where K is an integer greater than zero).

In some embodiments, the user simulator 144 is a compound AI system including an LLM that receives a synthetic user definition 140 and generates outputs, e.g., utterances, prompts, responses, etc., based on the received synthetic user definition 140, which is referred to herein as a simulation system. Components of the simulation system (or data necessary to implement one or more components of the simulation system) may be received from any suitable data store, such as the compound system store 142. The simulation system may simulate a single user for a single test case, multiple users for a single test case, a single user for multiple test cases, and/or multiple users for multiple test cases. Elements of the simulation system, such as an LLM implemented as part of a compound AI system, may be fine-tuned, for example, based on the synthetic user definition 140. In some embodiments, an LLM implemented as part of a compound AI system may receive one or more prompts that identify, reference, and/or utilize a corresponding synthetic user definition 140 in order to cause the user simulator 144 to modify one or more elements in order to simulate a user represented by the synthetic user definition 140. The simulation system may include a synthetic cognitive LLM that mimics aspects of cognition, for example, based on one or more attributes (such as personality attributes), reflection on prior interactions (including synthetic interactions and interactions from an ongoing test of a process), etc.

The process under test 146 may include any suitable process, such as an interactive compound AI system, a website, an automated phone interaction system, automated phone navigation systems, etc. For example, in various embodiments, the process under test includes a simulation of a service representative, such as a chatbot or automated phone system. The service representative receives user utterances, such as text or voice utterances, and generates responsive utterances using a similar medium. The user utterances received by the process under test 146 during testing are generated based on one or more simulated users.

The interaction between the user simulated by the user simulator 144 and the process under test 146 generates an interaction output 148 (e.g., one or more interaction traces). The interaction output 148 includes a record of the interactions between the simulated user and the process under test 146. The interaction output 148 may include, for example, a complete transcript of the interaction between the simulated user and the process under test 146, a summarization of the interaction, an annotated transcript of the interaction, and/or any other suitable output. The interaction output 148 may additionally include elements identifying attributes, goals, and/or other components of the simulated user.

In some embodiments, the interaction output 148 includes one or more annotations generated by the simulated user, the process under test 146, and/or additional annotation processes. For example, in some embodiments, the interaction output 148 includes grading feedback generated by one or more simulated graders. Simulated graders may include, but are not limited to, the user simulated by the user simulator 144, an objective grader simulated by the user simulator 144 and/or a separate compound AI system, a summary grader that summarizes grading received from other grading processes, etc. In some embodiments, the annotations include an indication of the number of turns, e.g., prompts and response pairs, which occurred during the interaction. The number of turns may be indicative of efficiency of a process under test 146 when dealing with the simulated user.

In some embodiments, a grading feedback annotation includes a narrative describing the interaction between the user simulated by the user simulator 144 and the process under test 146. The narrative may include, for example, an objective description of how the process under test 146 handled the interaction, such as indicating that the process “efficiently handled the user's request,” the process “failed to properly address the user's concerns,” or the process “achieved the user's goal but required additional prompting.” The narrative may additionally or alternatively include, for example, a user viewpoint assessment of the interaction from the perspective of the simulated user, such as indicating the process under test 146 “resolved my issue promptly,” “provided a positive interaction,” or “failed to address my needs.” Although specific examples are provided herein, it will be appreciated that any suitable narrative elements may be included in a narrative annotation.

In some embodiments, the grading feedback annotation includes a summary element providing a letter grade corresponding to an overall evaluation of the interaction, such as an “A,” “B,” etc. Summary elements may be provided from the perspective of one or more evaluators, such as, for example, a summary element provided from the perspective of an objective evaluator (e.g., objective grader), a summary element provided from the perspective of the simulated user, and/or a summary element provided from one or more additional perspectives. As one non-limiting example, a grading feedback annotation may include a summary element including a letter grade from the objective grader and a letter grade from the simulated user.

In some embodiments, grading feedback is generated by one or more compound AI systems, such as a system including one or more LLMs, referred to herein as grading systems, which receive a transcript of the interaction and generate grading feedback annotations. The grading systems may include any suitable LLM and may receive one or more prompts to cause the grading system to evaluate the transcript based on one or more evaluation criteria. Components of the grading systems (or data necessary to implement one or more components of the grading systems) may be obtained from any suitable data store, such as the compound system store 142.

The interaction output 148 is provided to a testing evaluator 150 to generate a testing output representing the overall outcome of the interaction between the user simulated by the user simulator 144 and the process under test 146. The testing evaluator 150 reviews portions of the provided interaction output 148, such as the annotations, transcript, etc., and determines whether the process under test 146 succeeded in the interaction (e.g., achieved a goal of the user/interaction, correctly handled an off-topic or out-of-bounds interaction) or failed in the interaction (e.g., did not achieve the goal of the user/interaction, escalated to a second interaction channel without attempting to achieve the goal of the interaction.)

In some embodiments, the testing evaluator 150 is a compound AI system, referred to herein as a testing system, that implements one or more models, such as a fine-tuned LLM to generate a testing output. The testing output may be generated in response to one or more testing attributes defined by the testing system. Testing attributes may include, but are not limited to, goals or sub-goals of an interaction. The testing attributes may be universal for all processes under test or may be process specific. Components of the testing system (or data necessary to implement components of the testing system) may be obtained from any suitable data store, such as the compound system store 142.

In some embodiments, the testing output of the testing evaluator 150 includes testing results from multiple tests of a process. For example, multiple tests by a single user or multiple tests by different users may be aggregated to generate a testing output indicative of a testing outcome of the process under test 146. The testing results may be aggregated by indicating an average result, a mean result, a result above or below a threshold, and/or any other suitable aggregation process.

In some embodiments, the testing output from the testing evaluator 150 is provided to one or more additional processes, such as model fine-tuning, refinement, and/or retraining processes that adjust the process under test 146 responsive to the testing outcome. The testing output may be provided in any suitable format useable by the one or more additional processes. In some embodiments, testing outputs responsive to multiple testing requests 136 are stored in a database and provided to an adjustment process upon request and/or at a predetermined interval.

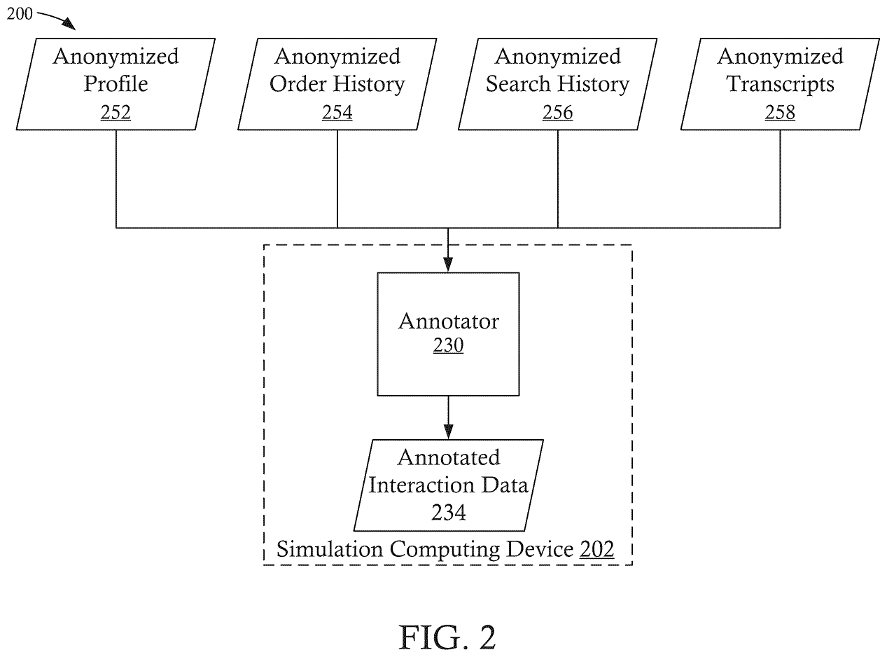

FIG. 2 depicts an example system 200 that implements an annotator 230 for generating annotated interaction data 234, in accordance with some embodiments. The annotator 230 is similar to the annotator 130 discussed above with respect to FIG. 1, and may be implemented by any suitable system, such as the processing resource 104 of the system 100. The annotator 230 receives a set of historical data and annotates the historical data for use by a synthetic user definition generator. The historical data may include, but is not limited to, anonymized profile data 252, anonymized order history data 254, anonymized search history data 256, and anonymized transcripts 258.

The anonymized profile data 252 may include, but is not limited to, data identifying non-personality aspects of as a user set, such as anonymized demographic information (e.g., identifying a user in an age range, identifying a user in a general geographic area). It will be appreciated that the user data utilized to generate a synthetic user is anonymized prior to use such that only general demographic information (and/or other information) is provided to the annotator 230 and used for synthetic user definition generation.

The anonymized order history data 254 may include data representative of order history for one or more users, such as prior purchase history, return history, etc. The anonymized order history data 254 may have certain orders removed and/or redacted as part of an anonymization process, may be represented as general brand, item type, or other affinities, and/or may be otherwise anonymized prior to use. The order history data 254 may include a limited period and/or a full historical order history.

The anonymized search history data 256 includes data representative of prior searches implemented through one or more search channels. For example, prior searches may include website searches, mobile application searches, automated agent searches, etc. The anonymized search history data 256 may undergo one or more processes to remove any sensitive or identifying search terms or results prior to use of the anonymized search history data 256 by the annotator 230.

The anonymized transcripts 258 may include machine generated and/or human generated transcripts of interactions between users and one or more communication channels. For example, the transcripts may include, but are not limited to, transcripts of interactions with current and/or prior iterations of chatbots, chat interactions with customer service representatives, transcripts of phone interactions with customer service representatives or automated systems, synthetic transcripts, and/or any other suitable transcript. The anonymized transcripts 258 may be processed to remove personally identifying and/or sensitive information prior to being provided to the annotator 230 for annotation.

As discussed above, historical data, such as the anonymized user profile data 252, the anonymized order history data 254, the anonymized search history data 256, the anonymized transcripts 258, and/or any other suitable historical interaction data, is provided to the annotator 230 to generate annotated interaction data 234. The annotator 230 may include one or more compound AI systems including, but not limited to, one or more models, such as a fine-tuned LLM, one or more rules-based annotation processes, databases, and/or any other suitable mechanism for annotating the anonymized profile data 252, the anonymized order history data 254, the anonymized search history data 256, and/or the anonymized transcripts 258.

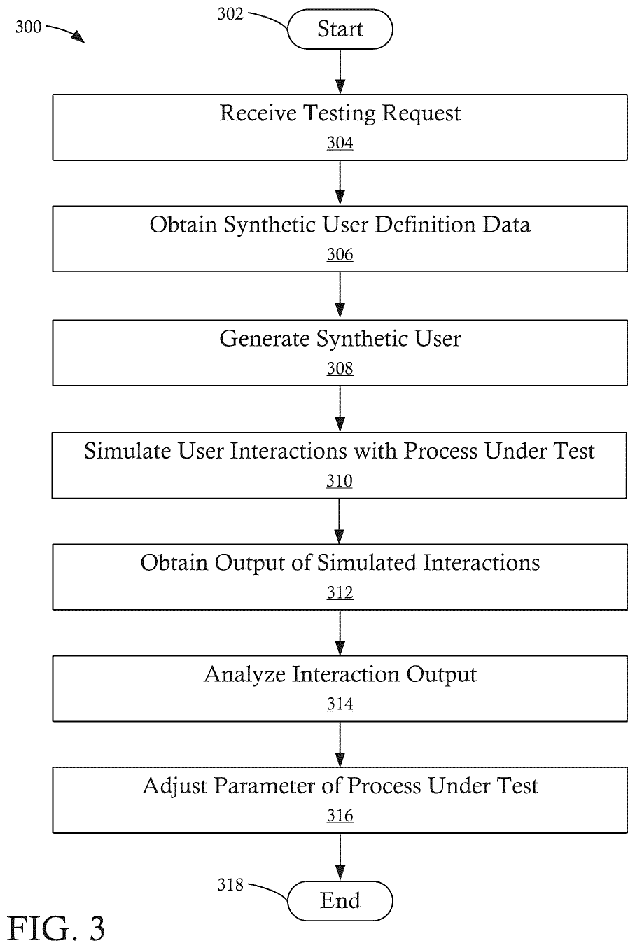

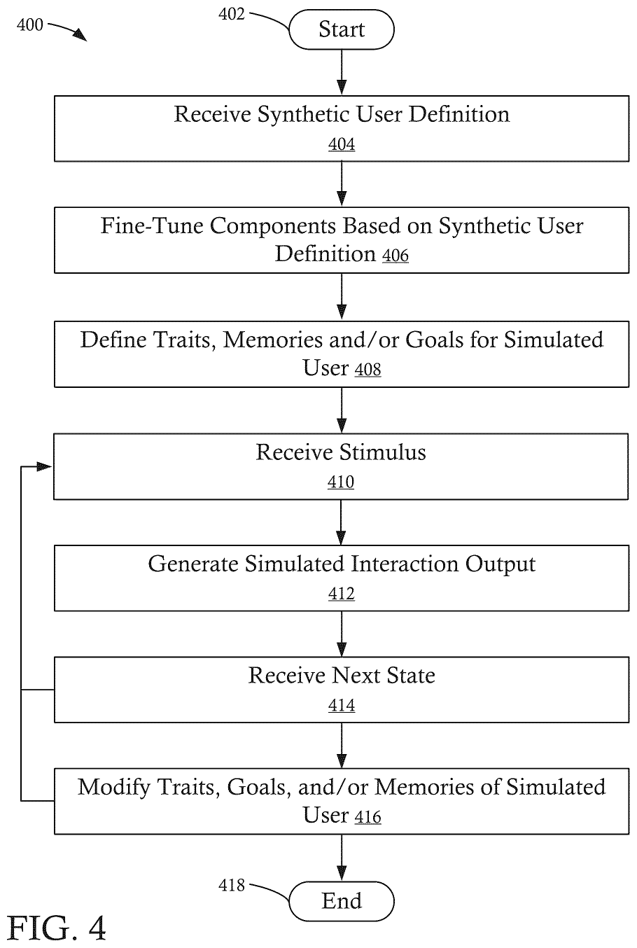

FIGS. 3 and 4 are flow diagrams depicting various example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 3 and 4 may be implemented in the form of executable instructions stored on a machine-readable medium and executed by a processing resource and/or in the form of electronic circuitry. For example, aspects of the methods may be described below as being performed by a simulation system, an example of which may be the simulation system 120 running on a hardware processing resource 104 of the simulation computing device 102 described above. Additionally, other aspects of the methods described below may be described with reference to other elements shown in FIG. 1 for non-limiting illustration purposes.

FIG. 3 is a flow diagram depicting an example method 300 for testing of trained processes using simulated users, in accordance with some embodiments. Method 300 starts at block 302 and continues to block 304, where a testing request is received. The testing request, such as testing request 136 illustrated in FIG. 1, includes identification of one or more processes to be tested by one or more simulated interactions. The testing request may further include one or more parameters of the test, such as synthetic user personas or attributes to be included in the test, one or more goals for the simulated users during the test, one or more test-specific memories or configurations for one or more simulated users, and/or any other suitable parameters for one or more simulated users and/or the process under test.

In some embodiments, the testing request may define one or more personas or attributes (e.g., traits, goals, memories, etc.) for one or more simulated users. As one non-limiting example, a testing request may include one or more trait definitions such as “membership in specific program,” “jovial,” “tech naive,” “escalates to supervisor,” “detail oriented,” etc., one or more goals or reasons for contact, such as “obtain hours for physical location,” “obtain address for physical location,” “obtain replacement for previously ordered item,” “obtain one or more available store services,” etc., and one or more memories such as “has purchased Brand X previously,” “has had poor interactions previously,” etc. It will be appreciated that the traits and/or memories may include a wide range of attributes that may be utilized to generate a synthetic user. Similarly, the goals and/or reasons for contact may include a wide range of motivations which may or may not relate to the process under test.

At block 306, one or more synthetic user definitions, such as one or more of the synthetic user definitions 140 illustrated in FIG. 1, matching one or more of the attributes identified in the testing request are obtained (e.g., retrieved), for example, from a synthetic user definition data store. Synthetic user definitions matching one or more of the defined attributes (e.g., one defined attribute, at least two defined attributes, at least three defined attributes, all defined attributes) may be retrieved from the data store directly, may be included within a testing request received at block 304, and/or may otherwise be obtained by a system executing the computer-implemented method 300, such as the simulation computing device 102. The obtained synthetic user definition(s) may include one or more synthetic user definitions that match each of the defined attributes, one or more synthetic user definitions that match at least one of the defined attributes, one or more synthetic user definitions that match at least one required defined attribute, etc.

At block 308, one or more synthetic users are simulated based on the obtained synthetic user definitions. The one or more synthetic users may be simulated by any suitable system or module, such as the user simulator 144 illustrated in FIG. 1. Synthetic users may be simulated by a compound AI system including one or more models, such as a compound AI system including an LLM that utilizes the synthetic user definitions to generate outputs (e.g., user utterances), receive inputs (e.g., system utterances), process changes in one or more parameters (e.g., an indication that an order has been returned or replaced), and/or perform additional actions from a perspective of a user as defined by a selected synthetic user definition.

At block 310, interactions between the synthetic user, for example as simulated by a user simulator, and a process under test, for example at least one machine learning process, are executed to generate an interaction output. As discussed above, an interaction output may include, but is not limited to, a complete transcript of the interaction between a simulated user and a process under test, a summarization of the interaction, an annotated transcript of the interaction, one or more elements generated during the interaction, and/or any other suitable record of interaction between the simulated user and the process under test.

At block 312, an output of the simulated user interactions with the process under test are obtained and, at block 314, the method 300 analyzes the interaction output to determine whether the at least one goal of the simulated interaction was achieved based on the interaction output. For example, a goal of a simulated interaction may be to return a product that was previously purchased. If the process under test successfully executes the return, the interaction output (such as the transcript of the interactions) will indicate the success and a determination is made that the goal was met. Alternatively, responsive to the process under test not successfully executing a return, such as escalating the interaction to a different interaction channel or refusing to complete the return, the interaction output would be labeled as not successful (e.g., failure). In some embodiments, the interaction output may be labeled with one or more additional labels such as, for example, a label indicating a partial success or partial failure, labels related to individual goals, and/or any other suitable labels.

At block 316, at least one parameter of the at least one process under test is adjusted in response to the determination of whether the interaction was successful based on the evaluation of the interaction output. For example, in some embodiments, responsive to an interaction being identified as unsuccessful, the interaction output may be provided to a training (or re-training) process for the corresponding process under test to adjust the process during a subsequent training round. The interaction output may be provided as a fine-tuning input, a labeled input for machine learning, and/or any other suitable input for retraining and/or adjustment of the corresponding process. As another example, in some embodiments, labeled interaction outputs from multiple test interactions may be aggregated into one or more training datasets that are used to adjust, fine-tune, train, and/or otherwise modify a process tested using synthetic interactions. The labeled interaction outputs may be used independently and/or in conjunction with additional data, such as interaction data obtained during interactions between deployed processes and one or more users. In some embodiments, when the analysis of the interaction output indicates a successful interaction, block 316 may be omitted. The method 300 proceeds to block 318, and the method 300 ends.

FIG. 4 is a flow diagram depicting an example method 400 for simulating a synthetic user, in accordance with some embodiments. Method 400 starts at block 402 and continues to block 404, where a synthetic user definition is received. As discussed above, a synthetic user definition includes attributes defining aspects of a synthetic user to be simulated, such as personality attributes, memory attributes, and goal attributes. The synthetic user definition may be provided in any suitable format and may be received (e.g., obtained) from any suitable location, such as a synthetic user definition data store.

At block 406, components of a simulation compound AI system, e.g., a simulation system, such as an LLM, are fine-tuned based on the received synthetic user definition to generate inputs and/or process outputs from a point-of-view of the simulated user. The components of the simulation system may be fine-tuned by providing the synthetic user definition with and/or in the form of a prompt provided to the corresponding component(s) (e.g., an LLM). The simulation system utilizes the synthetic user attributes and/or other elements of the synthetic user definition or prompt to modify the personality of a simulated user by the simulation system.

At block 408, one or more simulation-specific attributes, such as one or more simulation specific traits, memories, or goals of the synthetic user for a specific interaction may be generated. The simulation specific attributes may be similar to attributes defined in the synthetic user definition but specific to a particular simulated interaction. For example, a simulation-specific attribute may indicate that the simulated user is currently “upset,” or “exasperated,” and may have a simulation-specific goal of “completing interaction as quickly as possible.” As another example, a simulation-specific attribute may include a memory defining a prior interaction with the same or a similar process under test.

At block 410, the simulated user, e.g., the simulation system operating as the simulated user, receives a stimulus. A stimulus may include an initial stimulus indicating a start of an interaction. An initial stimulus may include a predetermined stimulus, e.g., a predetermined initial prompt, or may be generated by the simulation system based on an input stimulus, e.g., notification that the simulated user has been connected to a process under test. A stimulus may include additional prompts or utterances generated by the system under test and provided to the simulated personality, e.g., the simulation system. As yet another example, a stimulus may include an outside-interaction stimulus, such as an update to a memory of the simulated user and/or an updated goal for the interaction.

At block 412, a simulated interaction output is generated by the simulated user, e.g., by the simulation system. The simulated interaction output may include predetermined utterances, such as a predetermined initial utterance to be provided from the simulated user to the process under test, generated utterances, additional actions, etc. The simulation interaction output is provided from the simulation system to the process under test. For example, responsive to the process under test being a chatbot, the simulation system provides interaction outputs in the form of utterances that are provided as inputs to the process under test, e.g., the chatbot, which in turn generates responsive utterances to the received simulated interaction outputs of the simulated user.

At block 414, a next state is received by the simulated user. A next state may indicate a next action to be performed after generating an interaction output, such as wait for response. In some embodiments, a next state is provided by the process under test. In some embodiments, a next state includes a responsive utterance generated by the process under test and provided as an input to the simulation system, e.g., returning to block 410 to receive a next stimulus in the form of the responsive utterance. In some embodiments, after one or more predetermined occurrences, such as one or more interaction goals being satisfied, the next state received at block 414 may transition the simulation system to a review, or grading, state to generate a grading output for the simulated interaction, as discussed above. In some embodiments, after one or more predetermined occurrences, such as satisfaction of one or more interaction goals or completion of a review process, the next state indicates a completed simulation.

At block 416, one or more attributes, such as one or more traits, goals, or memories, of a simulated user may be updated in response to a received next state. The attributes may be updated as a response to a received next state, such as a response to a received responsive utterance. A simulated user may be updated to modify one or more attributes, such as one or more traits, one or more memories, one or more goals, etc. The updates may be based on a simulated reflection process implemented by the simulation system. The simulated reflection process may consider a prior set of one or more interactions (e.g., one or more utterances generated by the simulation system and one or more responsive utterances provided by the process under test) to identify updates to the attributes of the simulated user.

In some embodiments, attributes of the simulated user are updated such that only the most relevant attributes, such as the most relevant memories, of the simulated user are accessed or utilized during subsequent rounds of user simulation. For example, attributes of a simulated user may be updated and/or modified to emphasize, remove, or add long-term or short-term goals, modify one or more memories based on the simulated reflection process, store prior interactions as memories, etc. In some embodiments, a simulated user may include unchangeable attributes (e.g., simulated demographic information) and changeable attributes (e.g., goals, memories). At block 418, the method 400 ends.

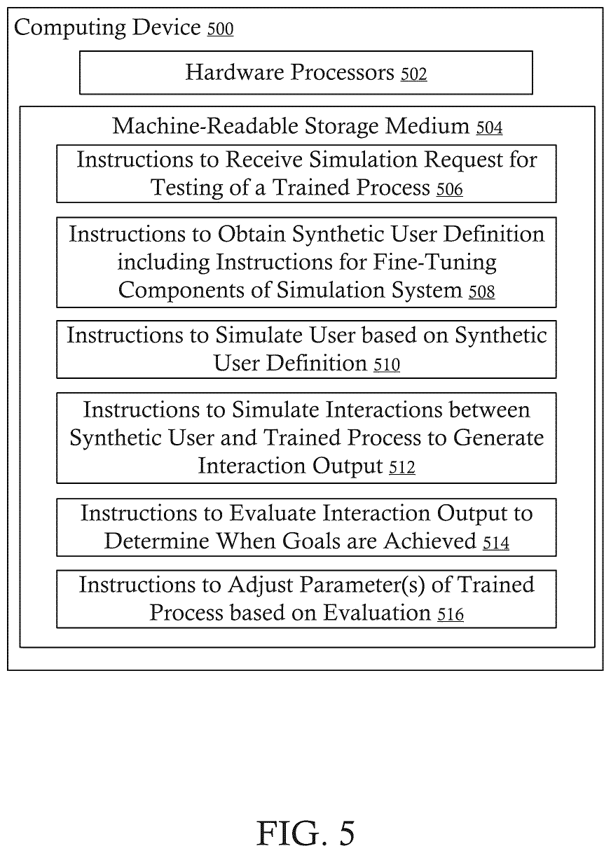

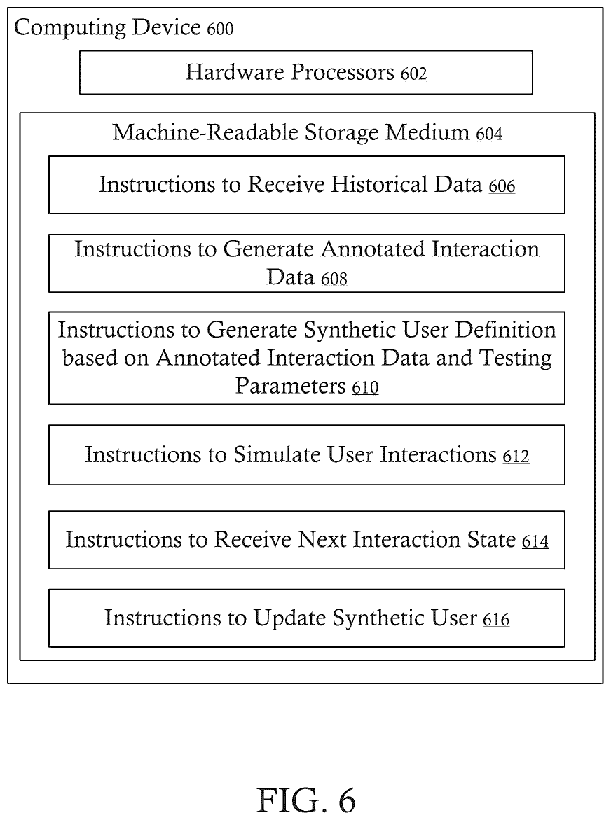

FIGS. 5 and 6 depict example systems 500, 600, respectively, that include non-transitory, machine-readable medium 504, 604, respectively, encoded with example instructions executable by processing resources 502, 602, respectively. In some implementations, the systems 500, 600 may be useful for implementing aspects of the simulation system 120 of FIG. 1, the annotator 230 of FIG. 2, or for performing aspects of methods 300 or 400 of FIGS. 3 and 4, respectively. For example, the instructions encoded on machine-readable medium 504 and/or 604 may be included in instructions 108 of FIG. 1. In some implementations, functionality described with respect to FIG. 1 may be included in the instructions encoded on machine-readable medium 504 and/or 604.

The processing resources 502, 602 may include a microcontroller, a microprocessor, central processing unit core(s), an ASIC, an FPGA, and/or other hardware device suitable for retrieval and/or execution of instructions from the machine-readable medium 504, 604 to perform functions related to various examples. Additionally or alternatively, the processing resources 502, 602 may include or be coupled to electronic circuitry or dedicated logic for performing some or all of the functionality of the instructions described herein.

The machine-readable medium 504, 604 may be any medium suitable for storing executable instructions, such as RAM, ROM, EEPROM, flash memory, a hard disk drive, an optical disc, or the like. In some example implementations, the machine-readable medium 504, 604 may be a tangible, non-transitory medium. The machine-readable medium 504, 604 may be disposed within the systems 500, 600, respectively, in which case the executable instructions may be deemed installed or embedded on the system. Alternatively, the machine-readable medium 504, 604 may be a portable (e.g., external) storage medium, and may be part of an installation package.

As described further herein, the machine-readable medium 504, 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 5 and 6.

With reference to FIG. 5, the machine-readable medium 504 includes instructions 506-516. Instructions 506, when executed, cause the processing resource 502 to receive a simulation request for testing of an automated interaction process. Instructions 508, when executed, cause the processing resource 502 to obtain a synthetic user definition including instructions for fine-tuning one or more components of a simulation system, such as an LLM included in the simulation system. Instructions 510, when executed, cause the processing resource 502 to simulate a synthetic user based on the synthetic user definition. Instructions 512, when executed, cause the processing resource 502 to simulate interactions between the simulated user and the automated interaction process to generate an interaction output. Instructions 514, when executed, cause the processing resource 502 to evaluate the interaction output to determine when one or more goals of the test are achieved. Instructions 516, when executed, cause the processing resource 502 to adjust one or more parameters of the automated interaction process based on the evaluation.

With reference to FIG. 6, the machine-readable medium 604 includes instructions 606-616. Instructions 606, when executed, cause the processing resource 602 to receive historical data. Instructions 608, when executed, cause the processing resource 602 to generate annotated interaction data. Instructions 610, when executed, cause the processing resource 602 to generate a synthetic user definition based on the annotated interaction data and received testing parameters. Instructions 612, when executed, cause the processing resource 602 to simulate user interactions with a process under test. Instructions 614, when executed, cause the processing resource 602 to receive a next interaction state. Instructions 616, when executed, cause the processing resource 602 to update a synthetic user.

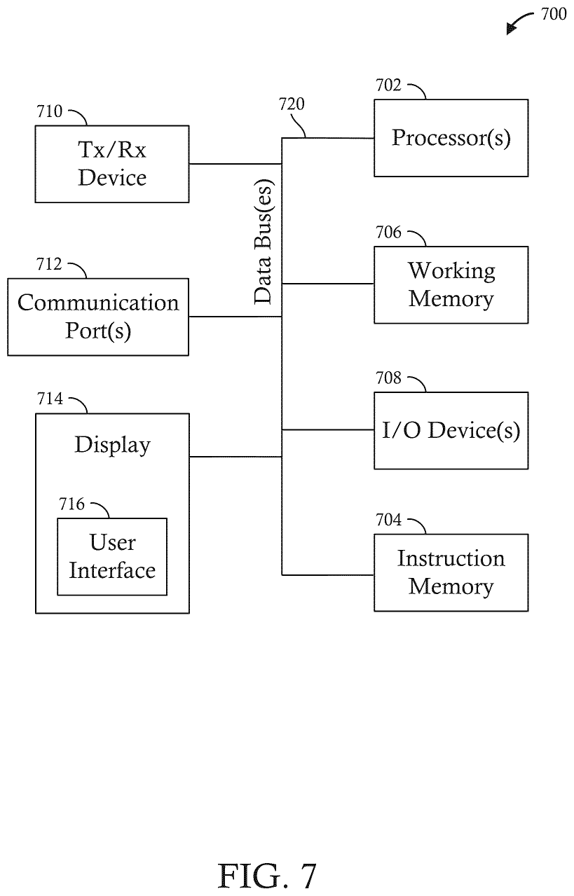

FIG. 7 depicts an example computer device 700 that implements one or more of the disclosed processes, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, input/output devices 708, transceiver 710, communication port(s) 712, display 714, and/or any other suitable elements each operatively coupled to one or more data buses 720. The data buses 720 allow for communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a medium access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an application specific integrated circuit (ASIC), a field programmable gate array (FPGA), a programmable logic device (PLD), etc.

In some embodiments, the one or more processing resources 702 implement an operating system (OS) and/or various applications. Examples of an OS include operating systems generally known under various trade names such as Apple macOS™, Microsoft Windows™, Android™, Linux™, and/or any other proprietary or open-source OS. Examples of applications include network applications, local applications, data input/output applications, and user interaction applications.

The instruction memory 704 may store instructions that are accessed (e.g., read) and executed by at least one of the one or more processing resources 702. For example, the instruction memory 704 may be a non-transitory, computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code stored on the instruction memory 704, embodying the function or operation. For example, the one or more processing resources 702 may execute code stored in the instruction memory 704 to perform one or more of any function, method, or operation disclosed herein.

Additionally, the one or more processing resources 702 may store data to, and read data from, the working memory 706. For example, the one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for generating synthetic user definitions and simulating users for testing of one or more processes, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, and Perl. In some embodiments a compiler or interpreter converts the instruction set into machine executable code for execution by the one or more processing resources 702.

The input/output devices 708 may include any suitable device that allows for data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 allow for communication with a network. For example, where the communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network, via the transceiver 710.

The communication port(s) 712 may include any suitable hardware, software, and/or a combination of hardware and software that is capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 allows for the programming of executable instructions in the instruction memory 704. In some embodiments, the communication port(s) 712 allow for the transfer (e.g., uploading or downloading) of data, such as machine learning model training data.

In some embodiments, the communication port(s) 712 couples the computing device 700 to a network. The network may include local area networks (LAN) as well as wide area networks (WAN) including without limitation the internet, wired channels, wireless channels, communication devices including telephones, computers, wire, radio, optical and/or other electromagnetic channels, and combinations thereof, including other devices and/or components capable of or associated with communicating data. For example, the communication environments may include in-body communications, various devices, and various modes of communications such as wireless communications, wired communications, and combinations of the same. In some embodiments, the transceiver 710 and/or the communication port(s) 712 may utilize any suitable communication protocols.

The display 714 may be any suitable display, and may display the user interface 716. For example, the user interface 716 may be a user interface for an application of a network environment operator, such as a testing environment operator, which allows a user to view and interact with the operator's website. In some embodiments, a user may interact with the user interface 716 by engaging the input/output devices 708. In some embodiments, the display 714 may be a touchscreen, where the user interface 716 is displayed on the touchscreen.

The display 714 may include a screen such as, for example, a Liquid Crystal Display (LCD) screen, a light-emitting diode (LED) screen, an organic LED (OLED) screen, a movable display, or a projection. In some embodiments, the display 714 may include a coder/decoder, also known as Codecs, to convert digital medium data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than are specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more graphical processing units (GPUs), one or more central processing units (CPUs), and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that synthetic user generation and testing of processes via simulated users as disclosed herein is only possible with the aid of computer-assisted machine-learning algorithms and techniques. In some embodiments, machine learning processes including large language models are used to perform operations that cannot practically be performed by a human, either mentally or with assistance, such as annotation of historical interaction data, generation of synthetic user definitions, simulation of users during interactions with processes, and evaluation of interaction outputs.

Although the subject matter has been described in terms of example embodiments, it is not limited thereto. Rather, the appended claims should be construed broadly, to include other variants and embodiments that may be made by those skilled in the art.

What is claimed is:

1. A system for testing of processes, comprising:
a processor; and
a non-transitory memory storing instructions, that when executed, cause the processor to:
annotate historical interaction data for at least one user to generate annotated interaction data;
generate a synthetic user definition including one or more machine-interpretable instructions for tuning a language model based on the annotated interaction data;
receive a simulation request to implement a test of at least one trained process;
simulate user interaction with the at least one trained process by a synthetic user based on the synthetic user definition, wherein the simulated user interaction generates an interaction output;
determine whether at least one goal of the simulated user interaction was met; and
label the interaction output based on the determination whether the at least one goal was met.

2. The system of claim 1, wherein the historical interaction data comprises at least one of:
anonymized profile data identifying non-personality aspects of the at least one user;
anonymized order history data identifying an order history for the at least one user;
anonymized search history data identifying prior searches implemented through one or more search channels; or
anonymized transcripts of interactions of the at least one user via one or more communication channels.

3. The system of claim 1, wherein the instructions, when executed, cause the processor to generate the synthetic user definition at least partially based on:
extracting one or more interaction elements within the annotated interaction data;
synthesizing the one or more interaction elements to generate one or more synthetic user attributes each representing an attribute of the synthetic user;
identifying aspects of the synthetic user definition; and
assigning the one or more synthetic user attributes based on the identified aspects.

4. The system of claim 1, wherein the instructions, when executed, cause the processor to simulate the user interaction with the at least one trained process at least partially based on:
determining attributes of the synthetic user based on the synthetic user definition including aspects of the synthetic user to be simulated;
tuning the language model by providing the synthetic user definition with a prompt to one or more components of the language model; and
generating one or more simulation-specific attributes based on a particular simulated interaction.

5. The system of claim 4, wherein the instructions, when executed, cause the processor to simulate the user interaction with the at least one trained process based further on:
receiving a stimulus by the synthetic user;
generating a simulated interaction output by the synthetic user based on the stimulus, the synthetic user definition, and the one or more simulation-specific attributes; and
receiving a next state by the synthetic user.

6. The system of claim 5, wherein the instructions, when executed, cause the processor to simulate the user interaction with the at least one trained process based further on:
generating a next simulated interaction output by the synthetic user in accordance with a determination that the next state indicates a next stimulus;
generating the interaction output in accordance with a determination that the next state indicates a completed simulation; and
updating one or more attributes of the synthetic user in response to the next state.

7. The system of claim 1, wherein the instructions, when executed, cause the processor to label the interaction output at least partially based on:
labeling the interaction output as a success when the at least one goal was met;
labeling the interaction output as a failure when the at least one goal was not met; and
labeling the interaction output as a partial success or partial failure when the at least one goal was partially met.

8. The system of claim 1, wherein the instructions, when executed, further cause the processor to:
adjusting at least one parameter of the at least one trained process during a subsequent training round in response to a determination that the interaction output is labeled as a failure; and
aggregating labeled interaction outputs from multiple test interactions into one or more training datasets to tune a process tested using synthetic interactions.

9. A computer-implemented method, comprising:
receiving a simulation request for implementing a test of at least one trained process, wherein the simulation request includes at least one goal;
obtaining a synthetic user definition including one or more machine-interpretable instructions for tuning a language model based on annotated interaction data;
generating a synthetic user based on the synthetic user definition;
simulating interactions between the synthetic user and the at least one trained process, wherein the interactions generate an interaction output;
determining whether the at least one goal was met based on the interaction output; and
adjusting at least one parameter of the at least one trained process based on the determination whether the at least one goal was met.

10. The computer-implemented method of claim 9, wherein the historical interaction data comprises at least one of:
anonymized profile data identifying non-personality aspects of at least one user;
anonymized order history data identifying an order history for the at least one user;
anonymized search history data identifying prior searches implemented through one or more search channels; or
anonymized transcripts of interactions of the at least one user via one or more communication channels.

11. The computer-implemented method of claim 9, wherein obtaining the synthetic user definition comprises:
extracting one or more interaction elements within the annotated interaction data;
synthesizing the one or more interaction elements to generate one or more synthetic user attributes each representing an attribute of the synthetic user;
identifying aspects of the synthetic user definition; and
assigning the one or more synthetic user attributes based on the identified aspects.

12. The computer-implemented method of claim 9, wherein simulating interactions between the synthetic user and the at least one trained process comprises:
determining attributes of the synthetic user based on the synthetic user definition including aspects of the synthetic user to be simulated;
tuning the language model by providing the synthetic user definition with a prompt to one or more components of the language model; and
generating one or more simulation-specific attributes based on a particular simulated interaction.

13. The computer-implemented method of claim 12, wherein simulating interactions between the synthetic user and the at least one trained process further comprises:
receiving a stimulus by the synthetic user;
generating a simulated interaction output by the synthetic user based on the stimulus, the synthetic user definition, and the one or more simulation-specific attributes; and
receiving a next state by the synthetic user.

14. The computer-implemented method of claim 13, wherein simulating interactions between the synthetic user and the at least one trained process further comprises:
generating a next simulated interaction output by the synthetic user in accordance with a determination that the next state indicates a next stimulus;
generating the interaction output in accordance with a determination that the next state indicates a completed simulation; and
updating one or more attributes of the synthetic user in response to the next state.

15. A non-transitory computer-readable medium having instructions stored thereon that, when executed by a processor, cause a device to perform operations comprising:
receiving a simulation request to implement a test of at least one trained process;
obtaining a synthetic user definition including one or more machine-interpretable instructions for tuning a language model based on annotated interaction data;
generating a synthetic user by applying the synthetic user definition to fine-tune a large language model;
simulating interactions between the synthetic user and the at least one trained process, wherein the interactions generate an interaction output; and
evaluating the interaction output to determine when the interactions achieved one or more predefined goals.

16. The non-transitory computer-readable medium of claim 15, wherein the historical interaction data comprises at least one of:
anonymized profile data identifying non-personality aspects of at least one user;
anonymized order history data identifying an order history for the at least one user;
anonymized search history data identifying prior searches implemented through one or more search channels; or
anonymized transcripts of interactions of the at least one user via one or more communication channels.

17. The non-transitory computer-readable medium of claim 15, wherein obtaining the synthetic user definition comprises:
extracting one or more interaction elements within the annotated interaction data;
synthesizing the one or more interaction elements to generate one or more synthetic user attributes each representing an attribute of the synthetic user;
identifying aspects of the synthetic user definition; and
assigning the one or more synthetic user attributes based on the identified aspects.

18. The non-transitory computer-readable medium of claim 15, wherein simulating interactions between the synthetic user and the at least one trained process comprises:
determining attributes of the synthetic user based on the synthetic user definition including aspects of the synthetic user to be simulated;
tuning the language model by providing the synthetic user definition with a prompt to one or more components of the language model; and
generating one or more simulation-specific attributes based on a particular simulated interaction.

19. The non-transitory computer-readable medium of claim 18, wherein simulating interactions between the synthetic user and the at least one trained process further comprises:
receiving a stimulus by the synthetic user;
generating a simulated interaction output by the synthetic user based on the stimulus, the synthetic user definition, and the one or more simulation-specific attributes; and
receiving a next state by the synthetic user.

20. The non-transitory computer-readable medium of claim 19, wherein simulating interactions between the synthetic user and the at least one trained process further comprises:
generating a next simulated interaction output by the synthetic user in accordance with a determination that the next state indicates a next stimulus;
generating the interaction output in accordance with a determination that the next state indicates a completed simulation; and
updating one or more attributes of the synthetic user in response to the next state.
